(19) United States
(12) Patent Application Publication
(10) Pub. No.: US 2010/0120574 A1
(43) Pub. Date: May 13, 2010

(54) HIGH REDUCTION COMBINED PLANETARY GEAR MECHANISM

(76) Inventor: Hitoshi Maekawa, Tsukuba-shi (JP)

Correspondence Address: OSTROLENK FABER GERB & SOFFEN, 1180 AVENUE OF THE AMERICAS, NEW YORK, NY, 100368403, US

(21) Appl. No.: 12/598,097

(22) PCT Filed: Mar. 11, 2008
(86) PCT No.: PCT/JP2008/054415

§ 371 Date: Oct. 29, 2009

(30) Foreign Application Priority Data
May 2, 2007 (JP) 2007-121621

(51) Int. Cl. F16H 1/46

(52) U.S. Cl. 475/331

(57) ABSTRACT

A high reduction combined planetary gear mechanism includes an input shaft (2), an output shaft (3), a first planetary gear mechanism (4), and a second planetary gear mechanism (5). The first planetary gear mechanism (4) includes a first sun gear (6) of which the center is coupled to the input shaft (2), a first internal gear (7), and a first planetary gear (8). A first support shaft (9) for rotatably supporting the first planetary gear (8) is fixed to a first carrier (10), and the output shaft (3) is fixed to the center of the first carrier (10). The second planetary gear mechanism (5) includes a second sun gear (11) of which the center is coupled to the input shaft (2), a second internal gear (12), and a second planetary gear (13). A second support shaft (14) for rotatably supporting the second planetary gear (13) is fixed to a stationary frame. The first internal gear (7) and the second internal gear (12) are formed on the inner peripheral surface of a rotatable common annular frame (16). The annular frame (16) is rotatably mounted on the input shaft (2).

### TECHNICAL FIELD

The present invention relates to a high reduction combined planetary gear mechanism in which the flexibility in design is expanded.

### BACKGROUND ART

Conventionally, a planetary gear mechanism including a sun gear, planetary gears, an internal gear, and a carrier holding planetary gears is widely applied to a drive system of a mechanical system due to the following excellent features.

(1) Realization of a high reduction ratio is possible

(2) The mechanism is compact with respect to its reduction ratio and transmission torque.

(3) A coaxial arrangement of input and output is possible

Conventionally, a combined planetary gear mechanism obtained by coupling respective elements of a plurality of planetary gear mechanisms is known, and the combined planetary gear mechanism realizes a high reduction ratio which cannot be realized by a single planetary gear mechanism.

However, in the conventional planetary gear mechanism, the reduction ratio which can be realized by the single planetary gear mechanism is about ¼ to 1/10, various conditions are imposed on a design, and the flexibility in selection of the number of teeth of a gear or the reduction ratio is unexpectedly small.

That is, since various conditions (geometric conditions, contiguity conditions, assembly conditions, etc.) are imposed on the design of the planetary gear mechanism, the flexibility in design is remarkably constrained. Especially, the assembly conditions that all planetary gears mesh with a sun gear and an internal gear correctly are extremely severe constraints, and the combinations of the number of teeth and reduction ratio which can be selected is significantly limited.

For example, in a case where three planetary gears are arranged at intervals of 120°, out of six combination candidates for the number of teeth, only one can be selected (refer to FIG. 4).

Meanwhile, although it is generally premised that the planetary gears are axisymmetrically arranged at regular intervals in the design of the planetary gear mechanism, this premise actually becomes a reason for the extremely severe constraints being applied as the assembly conditions. On the other hand, if a slight non-axisymmetrical arrangement of the planetary gears is permitted, the assembly conditions are excluded, and the flexibility in design can be significantly expanded.

For example, a configuration in which at least one planetary gear is arranged at a central angle position different from other planetary gears is known (refer to Patent Document 1). That is, the technique itself for arranging the planetary gears non-axisymmetrically to expand the flexibility in design is well-known.

For example, if three planetary gears are permitted to be arranged at angles other than 120°, out of two combination candidates for the number of teeth, one can be selected, and the flexibility in design is expanded by 3 times (when this is generalized, the flexibility in design become Nₚ times the number of planetary gears).

[Patent Document 1] Japanese Patent Examined Publication No. S38-12866

### DISCLOSURE OF THE INVENTION

### Problem that the Invention is to solve

However, when the planetary gears are non-axisymmetrically arranged, the total acting force between the gears does not become zero, and an unbalanced force is generated. Since this unbalanced force is revolved at the same speed of the rotation of the carrier, this causes noise and vibration depending on the applications and conditions of use of the planetary gear mechanism.

The object of the present invention is to solve the above conventional problems, and realize a high reduction combined planetary gear mechanism with high flexibility, and a reduced unbalanced force with only a small amount of noise and vibration.

### Means for Solving the Problems

In order to achieve the above object, the present invention provides a high reduction combined planetary gear mechanism including a plurality of planetary gear mechanisms. Planetary gears of at least one planetary gear mechanism of the plurality of planetary gear mechanisms are non-axisymmetrically arranged to expand the flexibility in design.

In order to achieve the above object, the present invention provides a high reduction combined planetary gear mechanism including a plurality of planetary gear mechanisms, wherein only a planetary gear mechanism in which a carrier does not rotate among the plurality of planetary gear mechanisms is non-axisymmetrically arranged.

In order to achieve the above object, the present invention provides a high reduction combined planetary gear mechanism including an input shaft, an output shaft, a first planetary gear mechanism, and a second planetary gear mechanism. The first planetary gear mechanism includes a first sun gear of which the center is coupled to the input shaft, a first internal gear, and a first planetary gears, first support shafts for rotatably supporting the first planetary gears are fixed to a carrier, and the output shaft is fixed to the center of the carrier. The second planetary gear mechanism includes a second sun gear of which the center is coupled to the input shaft, a second internal gear, and second planetary gears, and second support shafts for rotatably supporting the second planetary gears are fixed to a stationary frame. The first internal gear and the second internal gear are formed on the inner peripheral surface of a rotatable common annular frame, and the annular frame is rotatably mounted on the input shaft.

The high reduction combined planetary gear mechanism of claim 3, wherein planetary gears of either or both of the first planetary gear mechanism and the second planetary gear mechanism are non-axisymmetrically arranged.

### Advantage of the Invention

According to the high reduction combined planetary gear mechanism related to the present invention, the following effects are obtained.

(1) Flexibility in selecting the number of teeth of the combined planetary gear mechanism can be expanded to Nₚ (the number of planetary gears) times.

(2) A high reduction ratio of Nₚ times a conventional design can be realized.

(3) The use of a high-cost internal gear can be suppressed to a minimum.

(4) High-cost shifted gears are unnecessary, and only standard gears can be used.

(5) An unbalanced force is not revolved dynamically and vibration noises are not generated.

### BRIEF DESCRIPTION OF THE DRAWINGS

FIG. 1 is a conceptual diagram illustrating an embodiment of the present invention.

FIG. 2 is a perspective view illustrating the embodiment of the present invention.

FIG. 3 is a perspective view illustrating the embodiment of the present invention.

FIG. 4 is a table showing the propriety of the combination of a planetary gear mechanism.

FIG. 5 shows views illustrating problems and improvements by the combination of the planetary gear mechanism.

### DESCRIPTION OF REFERENCE NUMERALS AND SIGNS

1: HIGH REDUCTION COMBINED PLANETARY GEAR MECHANISM

2: INPUT SHAFT

3: OUTPUT SHAFT

4: FIRST PLANETARY GEAR MECHANISM

5: SECOND PLANETARY GEAR MECHANISM

6: FIRST SUN GEAR

7: FIRST INTERNAL GEAR

9: FIRST SUPPORT SHAFT

10 FIRST CARRIER

11: SECOND SUN GEAR

12: SECOND INTERNAL GEAR

13: SECOND PLANETARY GEAR

14: SECOND SUPPORT SHAFT

15: SECOND CARRIER

16: ANNULAR FRAME

### BEST MODE FOR CARRYING OUT THE INVENTION

The best mode for carrying out a high reduction combined planetary gear mechanism according to the present invention will be described below with reference to the drawings on the basis of an embodiment.

### Embodiment

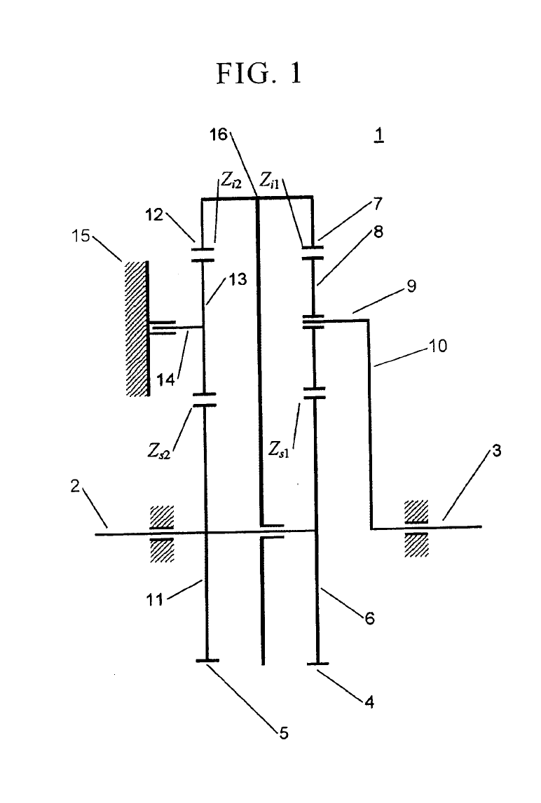

FIGS. 1 to 3 are views illustrating the embodiment of the high reduction combined planetary gear mechanism according to the present invention. The high reduction combined planetary gear mechanism 1 includes an input shaft 2, an output shaft 3, a first planetary gear mechanism 4, hand a second planetary gear mechanism 5.

The first planetary gear mechanism 4 has a first sun gear 6 of which the center is coupled to the input shaft 2, a first internal gear 7, and a first planetary gear 8, and a first support shaft 9 which rotatably supports the first planetary gear 8 is fixed to the first carrier 10. The output shaft 3 is fixed to the center of the first carrier 10.

The second planetary gear mechanism 5 has a second sun gear 11 of which the center is coupled to the input shaft 2, a second internal gear 12 and a second planetary gear 13, the second support shaft 14 which rotates with the second planetary gear 13 is rotatably supported by a second carrier 15, and the second carrier 15 is fixed to a stationary frame which is not shown.

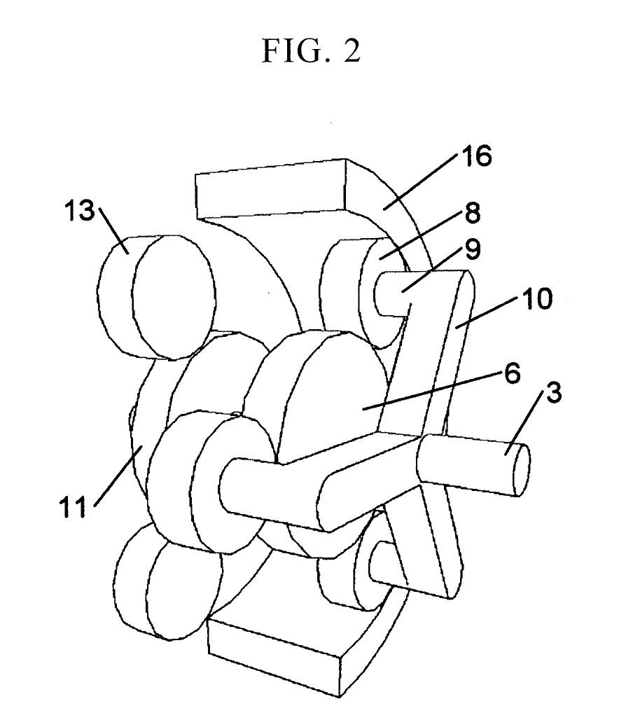

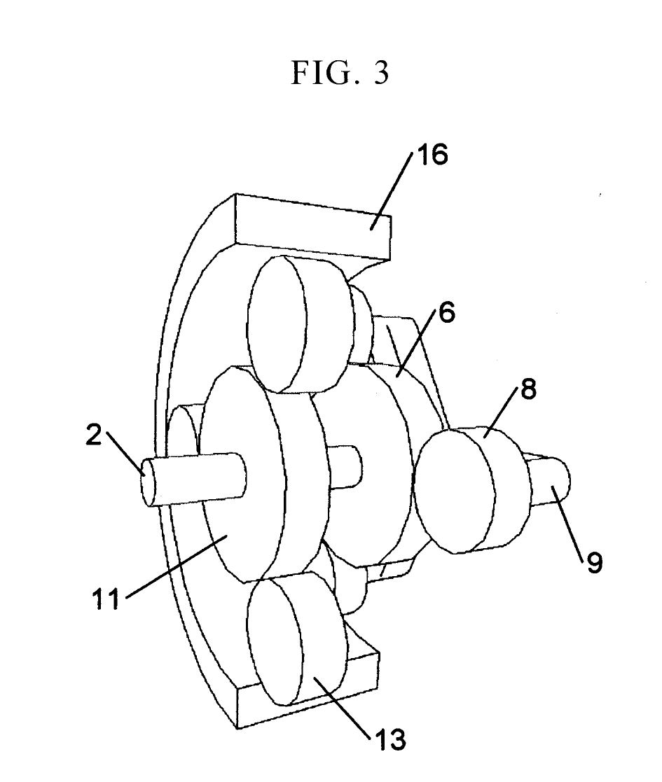

The high reduction combined planetary gear mechanism 1 according to the present invention is obtained by coupling the first planetary gear mechanism 4 and the second planetary gear mechanism 5 as follows as a configuration which obtains a high reduction ratio. That is, the first internal gear 7 and the second internal gear 12 are formed in the inner peripheral surface of a rotatable common annular frame 16. The annular frame 16 is rotatably mounted on the input shaft 2, as shown in FIG. 1. A configuration which is pivoted on the input shaft 2 is omitted in FIGS. 2 and 3.

By adopting the above configuration, the high reduction combined planetary gear mechanism according to the present invention exhibits the following functions.

Before that, the formulation in an independent planetary gear will be described. In using the planetary gear, input is given to two elements among the three elements of a sun gear, a carrier, and an internal gear, and output is taken out from the remaining one element, and the speed relationship of these three elements is defined by the following Formulas 1 and 2.

$$\begin{matrix}[ Formula 1 ] & \\ {ω}_{s} - α {ω}_{c} + ( α - 1 ) {ω}_{i} = 0 & ( 1 ) \\ [ Formula 2 ] & \\ α = 1 + \frac{{Z}_{i}}{{Z}_{s}} & ( 2 )\end{matrix}$$

ωₛ: Sun gear speed

Zₛ: Number of teeth of sun gears

ω_{c}: Carrier speed

ωᵢ: Internal gear speed

Zᵢ: Number of teeth of internal gears

A general planetary gear is used as a reducer in which the internal gear is fixed, input is made from the sun gear, and output is made from the carrier is performed. This is equivalent to adding a constraint condition to Formula 1, and speed relationship changes as in the following Formula 3.

$$\begin{matrix}[ Formula 3 ] & \\ {ω}_{c} = \frac{1}{α} {ω}_{s} & ( 3 )\end{matrix}$$

Next, it can be considered that the internal gear is not fixed, but rotates actively in a direction opposite to the rotation of the carrier. Then, since a portion of the rotation of the carrier is cancelled by the reverse rotation of the internal gear, the speed of the carrier becomes smaller than that of Formula (3), and a high reduction ratio can be obtained. Thus, the relationship of the following Formula 4 is introduced into the speed of the sun gear and the internal gear.

$$\begin{matrix}[ Formula 4 ] & \\ {ω}_{i} = - \frac{1}{β} {ω}_{s} & ( 4 )\end{matrix}$$

When the constraint of Formula 4 is added to Formula 1, the reduction ratio γ from the sun gear to the carrier can be derived as the following Formulas 5 and 6.

$$\begin{matrix}[ Formula 5 ] & \\ {ω}_{c} = \frac{1}{γ} {ω}_{s} & ( 5 ) \\ [ Formula 6 ] & \\ γ = \frac{α β}{1 - α + β} & ( 6 )\end{matrix}$$

It can be understood from Formula 6 that a very high reduction ratio is obtained in the case of 1−α+β≅0. In addition, the limit of β→∝ is equivalent to a state where the internal gear is fixed. At that time, Formulas 3 and 5 coincide with each other.

The high reduction combined planetary gear mechanism according to the present invention will be described with reference to the formulation in the above independent planetary gear. Here, as for the first planetary gear mechanism 4, the number of teeth of the first sun gear 6 is defined as Zₛ₁, the number of teeth of the first internal gear 7 is defined as Zᵢ₁, the number of teeth of the second sun gear 11 is defined as Zₛ₂, and the number of teeth of the second internal gear 12 is defined as Zₛ₂.

Then, the first planetary gear mechanism 4 is equivalent to the above independent planetary gear mechanism, and the internal gear thereof is rotated by the second planetary gear mechanism 5. Here, on the basis of Formulas 2 and 6, the speed ratios α and β which appear in formulation can be expressed as the following Formulas 7 to 9 according to the number of teeth of each gear.

$$\begin{matrix}[ Formula 7 ] & \\ α = 1 + \frac{{Z}_{i 1}}{{Z}_{s 1}} & ( 7 ) \\ [ Formula 8 ] & \\ β = \frac{{Z}_{i 2}}{{Z}_{s 2}} & ( 8 ) \\ [ Formula 9 ] & \\ γ = \frac{{Z}_{i 2} ( {Z}_{s 1} + {Z}_{i 1} )}{{Z}_{s 1} {Z}_{i 2} - {Z}_{s 2} {Z}_{i 1}} & ( 9 )\end{matrix}$$

Moreover, in order to simplify a mechanism, when the number of teeth of the first internal gear 7 and the number of teeth of the second internal gear 12 are made equal to each other, the reduction ratio γ expressed by Formula 9 can be modified as a reduction-ratio γ′ expressed by the following Formula 10.

$$\begin{matrix}[ Formula 10 ] & \\ {γ}^{′} = \frac{{Z}_{s 1} + {Z}_{i 1}}{{Z}_{s 1} - {Z}_{s 2}} & ( 10 )\end{matrix}$$

Here, Formulas 9 and 10 show the reduction ratios of the combined planetary gear mechanism, and when the denominators thereof are brought close to zero, high reduction ratios are obtained. This is equivalent to reducing the difference in number of teeth between the first sun gear 6 of the first planetary gear mechanism 4 and the second sun gear 11 of the second planetary gear mechanism 5 in Formula 10. Additionally, the same direction (Zₛ₁>Zₛ₂, γ′>0) or opposite direction (Zₛ₁<Zₛ₂, γ′<0) of input/output rotation can be set depending on the magnitude relation of the numbers of teeth of the first and second sun gears.

As described above, in the high reduction combined planetary gear mechanism 1 according to the present invention, the function that a high reduction ratio is obtained can be exhibited by appropriately setting the difference in number of teeth between the first sun gear 6 of the first planetary gear mechanism 4 and the second sun gear 11 of the second planetary gear mechanism 5.

As a feature of the high reduction combined planetary gear mechanism according to the present invention, there is the extremely remarkable effect that the assembly conditions of the planetary gear are relaxed. This point will be described below.

In the conventional planetary gear design, although Nₚ planetary gears are axisymmetrically arranged at regular intervals on a carrier, all the planetary gears need to correctly mesh with a sun gear and an internal gear. This assembly condition is expressed by the following Formula 11 by the numbers of teeth Zₛ of the sun gear and the numbers of teeth Zᵢ of the internal gear.

[Formula 11]

Zₛ+Zᵢ=MNₚ (11)

M: Arbitrary integer

Nₚ: Number of planetary gears

Zₛ, Zᵢ: Both are even numbers or odd numbers

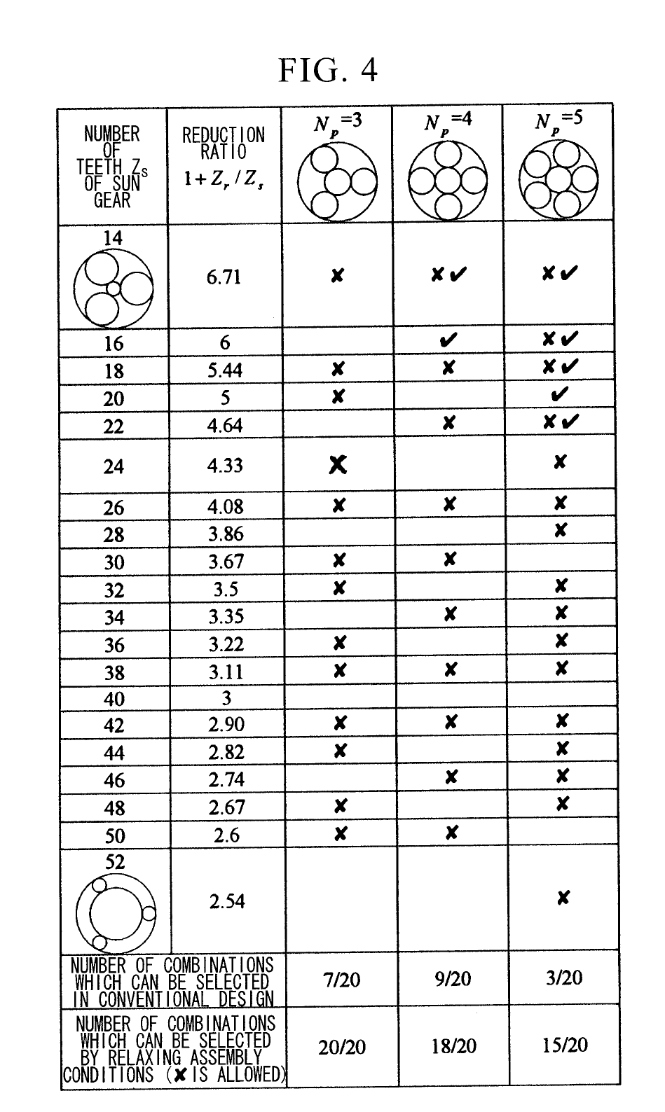

However, although the combination of the numbers of teeth which can be selected by Formula 11 have already been described, the combination is remarkably limited, and the number of teeth of a sun gear which can be selected with respect to the number of teeth of a certain internal gear is only one out of 2Nₚ ways, and the planetary gear cannot be correctly assembled in the remaining 2Nₚ−1 ways (refer to FIG. 4).

On the other hand, according to the high reduction combined planetary gear mechanism related to the present invention, if a slight non-axisymmetrical arrangement of the planetary gear is permitted, assembly conditions can be significantly relaxed, and the number of teeth which can be selected can be expanded to one out of two ways. For example, when the number of the planetary gears is Nₚ=3 in both the first and second planetary gear mechanisms 4 and 5, only ⅙ can conventionally be selected from the candidates of the number of teeth, whereas one half of the candidates can be selected if the assembly conditions are relaxed. The concrete process of the relaxation of the assembly conditions will be shown below.

In addition, which one out of the numbers of teeth of the first planetary gear mechanism 4 and the second planetary gear mechanism is first determined is not particularly limited. Here, when the noise vibration caused by an unbalanced force becomes a problem, it is preferable to first determine the number of teeth of the first planetary gear mechanism 4 so that the first planetary gear mechanism 4 is axisymmetrically arranged, and to determine the second planetary gear mechanism 5 accordingly.

(1) As shown in the following Formula 12, the integer quotient M and remainder ΔM are obtained by dividing the sum Zₛ+Zᵢ of the numbers of teeth by Nₚ.

[Formula 12]

Zₛ+Zᵢ=MNₚ+ΔM(1≦ΔM≦Nₚ−1) (12)

Here, if the remainder is zero (this applies to the first planetary gear mechanism 4 in this example), planetary gears may be axisymmetrically arranged at regular intervals, and the subsequent process is unnecessary. Here, if the remainder is not zero (this applies to the second planetary gear mechanism in this example), the non-axisymmetrical arrangement of the planetary gears is necessary, and the subsequent process proceeds.

(2) As shown in the following Formula 13, an integer Mₖ(1≦k≦Nₚ) equivalent to the arrangement interval of the planetary gears is determined, and Mₖ corresponding to ΔMₖ=1 and ΔMₖ=0 is distributed as uniformly as possible. This is equivalent to uniformly distributing the remainder of Formula 12, thereby minimizing the asymmetry of the arrangement of the planetary gears.

[Formula 13]

Mₖ=M+ΔMₖ (13)

ΔMₖ=1(ΔM places of Nₚ places)

ΔMₖ=0(Nₚ-ΔM places of Nₚ places)

(3) Planetary gears may be arranged on a carrier in an interval ratio of M₁:M₂: . . . MNₚ. Here, “ interval ratio of M₁:M₂: . . . MNₚ” is as follows, for example, when being based on the first planetary gear mechanism 4 and the second planetary gear mechanism in the embodiment

<As for First Planetary Gear Mechanism 4>

Division of Formula 12: (50+100)/3=50; Remainder=0

Can be axisymmetrically arranged since the formula can be divided

Interval ratio 1:1:1

<As for Second Planetary Gear Mechanism>

Division of Formula 12: (48+100)/3=49; Remainder=1

Can be non-axisymmetrically arranged since there is a remainder.

Interval ratio 49:49:49+1=49:49:50

(Configuration Example)

A concrete example of the high reduction combined planetary gear mechanism according to the present invention will be described below. The number Nₚ=3 of the planetary gears and the internal gear are the same (Zᵢ₂=Zᵢ₁) in the first planetary gear mechanism 4 and the second planetary gear mechanism 5.

The number of teeth of the first planetary gear mechanism 4 aims at obtaining a positive reduction ratio which is as large as possible under the condition where the sun gear Zₛ₁=50 and the internal gear Zᵢ₁=100. Since the first planetary gear 8 of the first planetary gear mechanism 4 satisfies the assembly conditions of Formula 11, the first planetary gears can be axisymmetrically arranged at regular intervals of 120°.

If the number of teeth Zₛ₂ of the second sun gear of the second planetary gear mechanism 5 satisfies the following condition in Formula 10, a positive high reduction ratio can be obtained.

Zₛ₂≅Zₛ₁

Zₛ₂<Zₛ₁

Zₛ₂ is the same even number as Zᵢ₂=100

In this case, the number of teeth which satisfies the above condition in the immediate vicinity of the Zₛ₁=50 is Zₛ₂=48, and a high reduction ratio of γ′=75 can be obtained.

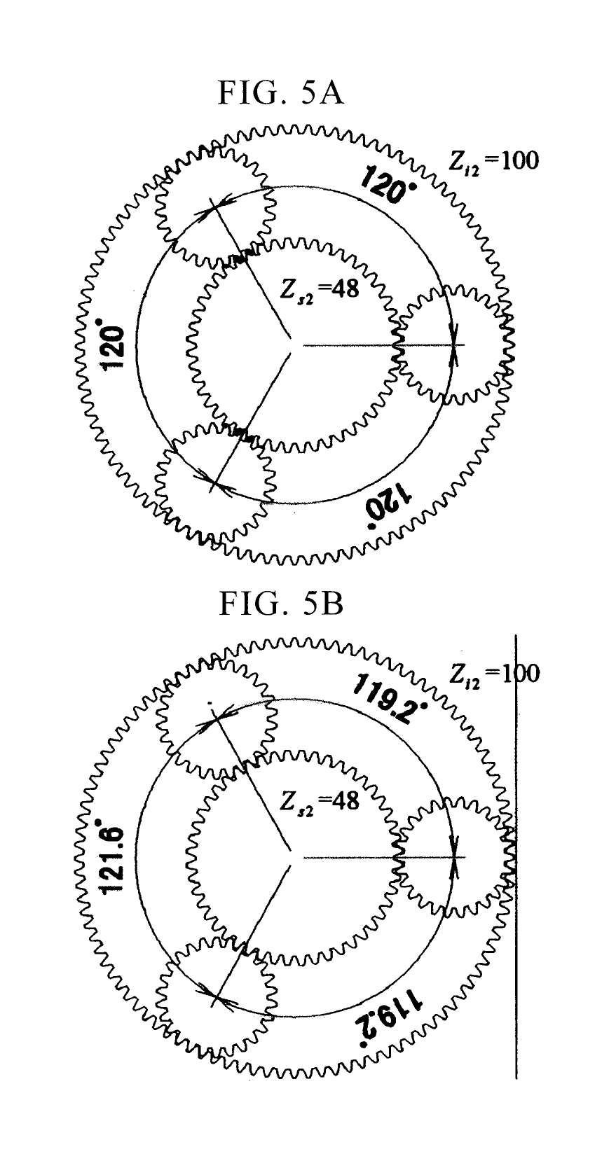

However, since the number of teeth (the number of teeth of the sun gear Zₛ₂=48, and the number of teeth of the internal gear Zᵢ₂=100) of the second planetary gear mechanism 5 does not satisfy the assembly conditions of the above Formula 11, the sun gear and the planetary gear interfere with each other in a region shown by an arrow in FIG. 5A. Then, when the non-axisymmetrical arrangement is permitted and the assembly conditions are relaxed along the above process, all the planetary gears can be correctly assembled in FIG. 5B.

On the other hand, when the planetary gears are axisymmetrically arranged without relaxing the assembly conditions, the number of teeth which satisfies the assembly conditions in the intermediate vicinity of the Zₛ₁=50 becomes Zₛ₂=44, and the reduction ratio γ′ obtained will decrease to 25 which is one third of the aforementioned value.

The quantitative evaluation when the planetary gears have the above asymmetry is as follows.

Arrangement interval of planetary gears: interval ratio 49:49:50

Geometric unsymmetrical amount: (Moving distance of planetary gear shaft from axisymmetrical position)
0.52 times as large as gear module
2.0% of diameter of planetary gear (number of teeth 26)

Mechanical unsymmetrical amount: 0.82%

|Unbalanced force|/(Number of planetary gears×|Acting force between planetary gear and sun gear|)

In addition, the mechanical unsymmetrical amount is defined as |Unbalanced force|/(Number of planetary gears×|Acting force between planetary gear and sun gear|). When the value of the mechanical unsymmetrical amount is calculated in this embodiment, the value becomes 0.82%.

As for the asymmetry of the high reduction combined planetary gear mechanism according to the present invention, the expansion of the flexibility in design, and high reduction ratio may be suitably adopted by taking into consideration conditions, such as the intended purpose and conditions of use of the combined planetary gear mechanism.

As described above, according to the high reduction combined planetary gear mechanism related to the present invention, the assembly conditions can be relaxed, and the following remarkable effects are obtained.

(1) Realization of high reduction ratio

A high reduction ratio, Nₚ times a conventional design where the assembly conditions are not relaxed, can be obtained.

(2) Only one internal gear is used

Even when the assembly conditions are not relaxed, the reduction ratio of, for example, γ=97 is obtained with the numbers of teeth including Zₛ₁=50, Zᵢ₁=100, Zₛ₂=47, and Zᵢ₂=97. In this case, however, two kinds of internal gears having different numbers of teeth are required.

However, generally, compared with the external gear, the internal gear is manufactured with difficulty, and high costs, and is also limited in the selection of the number of teeth. On the other hand, according to the present invention, since the numbers of teeth of two internal gears are equal to each other, one internal gear can be shared in an actual mechanism.

(3) Unbalanced force is not revolved dynamically.

As a result of arranging planetary gears non-axisymmetrically, the total of an acting force in a place where the sun gear and the planetary gears contact each other does not become zero, but a radial unbalanced force is generated. Since this unbalanced force is revolved at the same speed as the rotation of the carrier, there is a possibility that noise and vibration will be generated. However, according to the present invention, since the carrier of the second planetary gear mechanism is fixed, unbalanced force is not revolved. That is, if the first planetary gear mechanism has an axisymmetrical arrangement and the second planetary gear mechanism has a non-axisymmetrical arrangement, even if the assembly conditions are relaxed, the direction of the unbalanced force is constant, and noise and vibrations are not generated.

Although the best mode for carrying out the high reduction combined planetary gear mechanism according to the present invention has been described above on the basis of the embodiment, it is needless to say that the present invention is not limited to such an embodiment, and there are various embodiments within the range of technical matters set forth in the claims.

1. A high reduction combined planetary gear mechanism comprising a plurality of planetary gear mechanisms, wherein planetary gears included in at least one planetary gear mechanism of the plurality of planetary gear mechanisms are non-axisymmetrically arranged to expand the flexibility in design.

2. A high reduction combined planetary gear mechanism comprising a plurality of planetary gear mechanisms, wherein only a planetary gear mechanism in which a carrier does not rotate among the plurality of planetary gear mechanisms is non-axisymmetrically arranged.

3. A high reduction combined planetary gear mechanism comprising an input shaft, an output shaft, a first planetary gear mechanism, and a second planetary gear mechanism,
wherein the first planetary gear mechanism includes a first sun gear of which the center is coupled to the input shaft, a first internal gear, and first planetary gears, first support shafts for rotatably supporting the first planetary gears are fixed to a carrier, and the output shaft is fixed to the center of the carrier,
wherein the second planetary gear mechanism includes a second sun gear of which the center is coupled to the input shaft, a second internal gear, and second planetary gears, and second support shafts for rotatably supporting the second planetary gears are fixed to a stationary frame,
wherein the first internal gear and the second internal gear are formed on the inner peripheral surface of a rotatable common annular frame, and the annular frame is rotatably mounted on the input shaft.

4. (canceled)
